(19) United States
(12) Patent Application Publication
(10) Pub. No.: US 2009/0184179 A1
(43) Pub. Date: Jul. 23, 2009

(54) SPRINKLER FIXING-SWITCH

(76) Inventor: YenKun HSUEH, Ta Li City (TW)

Correspondence Address: SINORICA, LLC, 2275 Research Blvd., Suite 500, ROCKVILLE, MD, 20850, US

(21) Appl. No.: 12/017,332

(22) Filed: Jan. 21, 2008

(51) Int. Cl. B05B 9/00; F16K 35/00

(52) U.S. Cl. 239/525; 137/384.2

(57) ABSTRACT

The present invention relates to a sprinkler fixing-switch, wherein the main body is installed with a pressure switch and said main body is connected with a control handle. The control handle connected to the main body presses on the pressure switch, and the main body is pivoted with a clicked-in fixing part. When said control handle connecting to the main body presses on the pressure switch, the clicked-in fixing part installed on the main body is clicked onto the control handle, rendering the control handle pressed on the pressure switch installed on the main body in order to achieve the effect of ease in control and operation.

### BACKGROUND OF THE INVENTION

(a) Field of the Invention

The present invention relates to a sprinkler fixing-switch, in particular a technology belongs to the application of water hose control device.

(b) Description of the Prior Art

FIG. 5 shows the sprinkler of prior art, which comprises a main body 10′; said main body 10′ connects to a control handle 30′ and said main body 10′ is installed with a pressure switch 11′; the control handle 30′ connecting to main body 10′ presses on pressure switch 11′ through hitching a restraining ring 40 to main body 10′ and control handle 30′, so that said restraining ring 40 restrains control handle 30′ by fixing and pressing the installed pressure switch 11′ to main body 10′. User must hold main body 10′ and press control handle 30′ while at the same time must hitch the restraining ring 40 outside the main body 10′ and control handle 30′, which is not easy in control and operation.

### SUMMARY OF THE INVENTION

### <Motive of New Invention>

In view of above stated problem, the present invention is to complete the sprinkler fixing-switch for the improvement of the inconvenience of control and operation for the sprinkler.

### <Purpose of New Invention>

The main purpose of the present invention is in providing a sprinkler fixing-switch, wherein its main body is connected to a control handle and said main body is installed with a pressure switch, which is in turn connected to the control handle of the main body for the pressing against pressure switch. In addition, the main body is pivoted with a clicked-in fixing part; through control of pressure against the pressure switch of the control handle, the clicked-in fixing part installed on the main body is controlled by the control handle so that the control handle is fixed and controlled on the pressure switch installed on the main body in order to achieve the effect of ease in control and operation.

### BRIEF DESCRIPTION OF THE DRAWINGS

FIG. 1 is the perspective view of the assembly state of the present invention.

FIG. 2 is the perspective view of the exploded view of the present invention.

FIG. 3 is the side view of the present invention.

FIG. 4 is the illustration of the action state of the present invention.

FIG. 5 is the illustration of the prior art of the present invention.

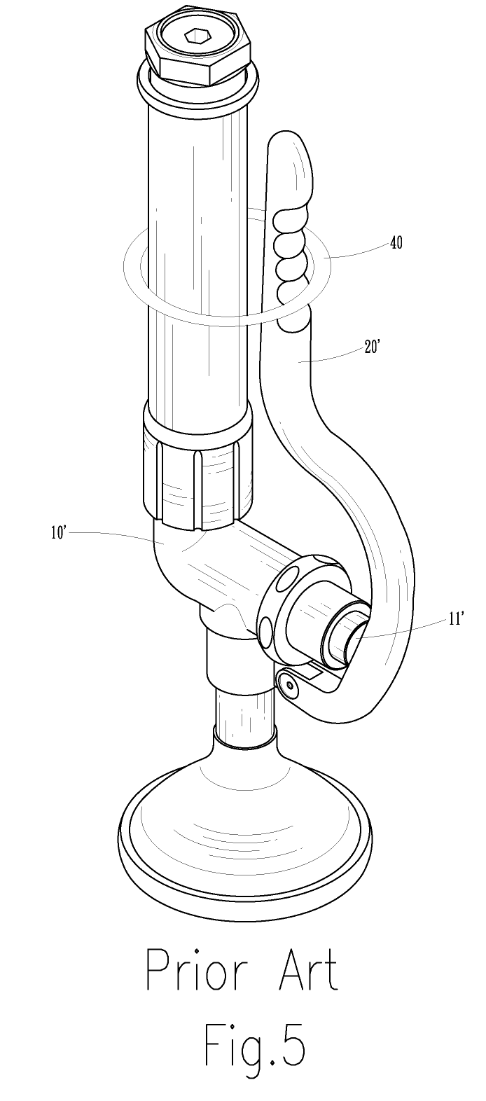

### DETAILED DESCRIPTION OF THE PREFERRED EMBODIMENTS

In order for your reviewing committee to further understand the structure, feature, and others of the present invention, the preferred embodiment of the present invention is described in detail below. However, the preferred embodiment described here is only for the purpose of providing explanation for the illustrated preferred embodiment and is by no means restricted to the examples described in this patent application.

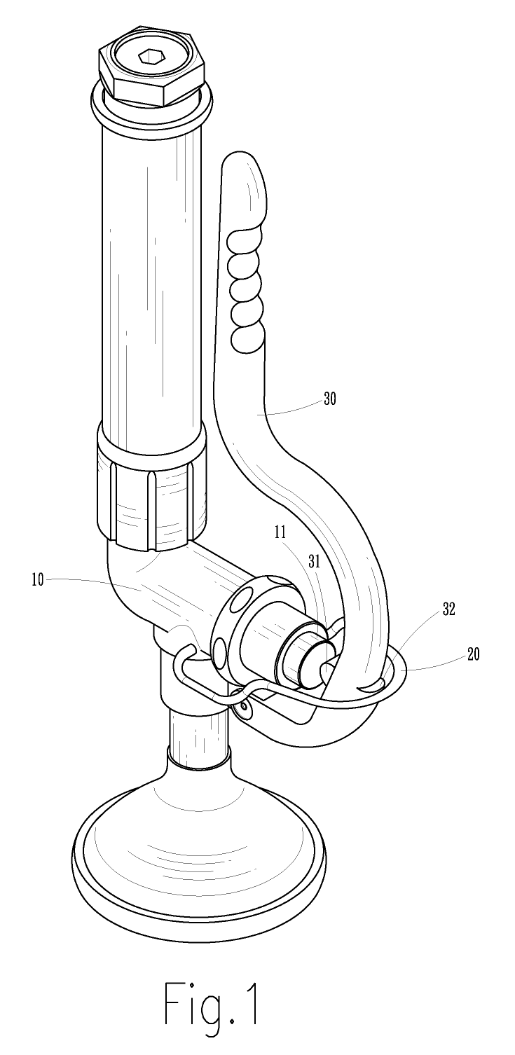

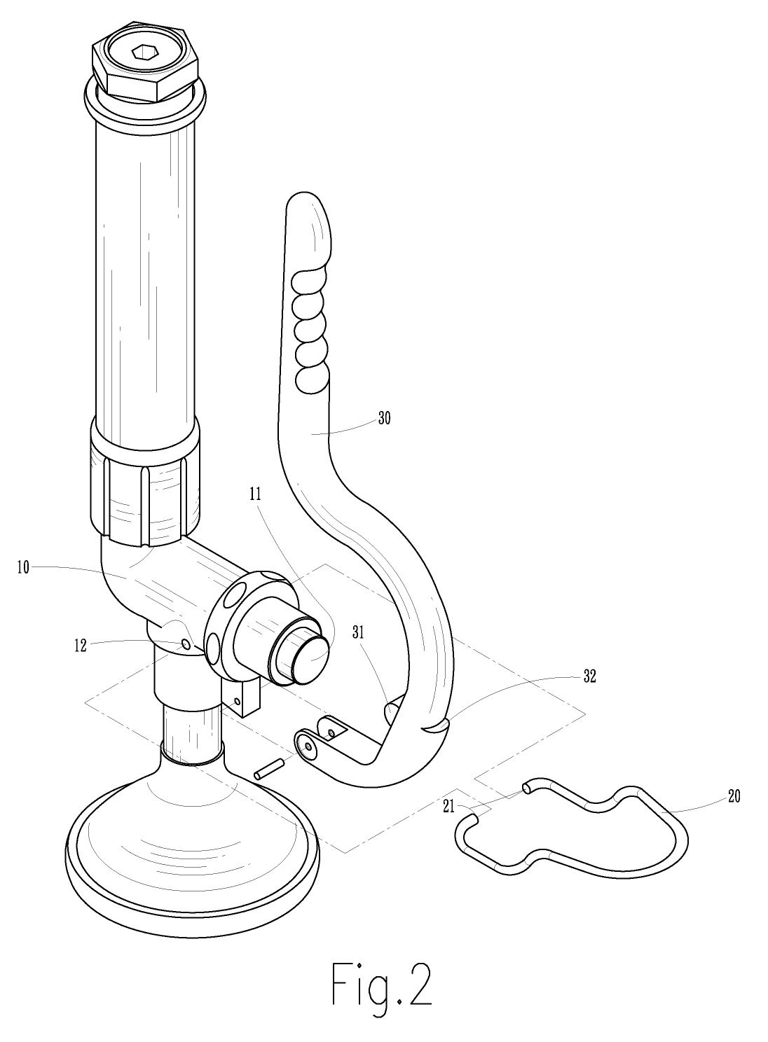

Please refer to FIGS. 1 and 2 for the description below, wherein the illustrations show the perspective view, exploded view, and side view of the sprinkler fixing-switch of the present invention comprising:

A main body 10, said main body 10 is installed with a pressure switch 11; in addition, the other side of the pressure switch 11 of the main body 10 is installed with two connecting holes 12;

A click-on fixing part 20, said clicked-in fixing part 20 is installed with a connecting-end section 21; said connecting-end section 21 is clicked-in to the connecting hole 12 of main body 10 so that the clicked-in fixing part 20 is clicked into the main body 10;

A control handle 30, said control handle 30 is installed with a protruding point control section 31 and a clicked-in control section 32, whereas said control handle 30 is pivoted to main body 10; its protruding point control section 31 is pressed against the pressure switch 11 of main body 10, while its clicked-in control section 32 is clicked in to the clicked-in fixing part 20 of connecting hole 12 of main body 10;

Through the matching of above stated structure, the sprinkler fixing-switch of the present invention is completed.

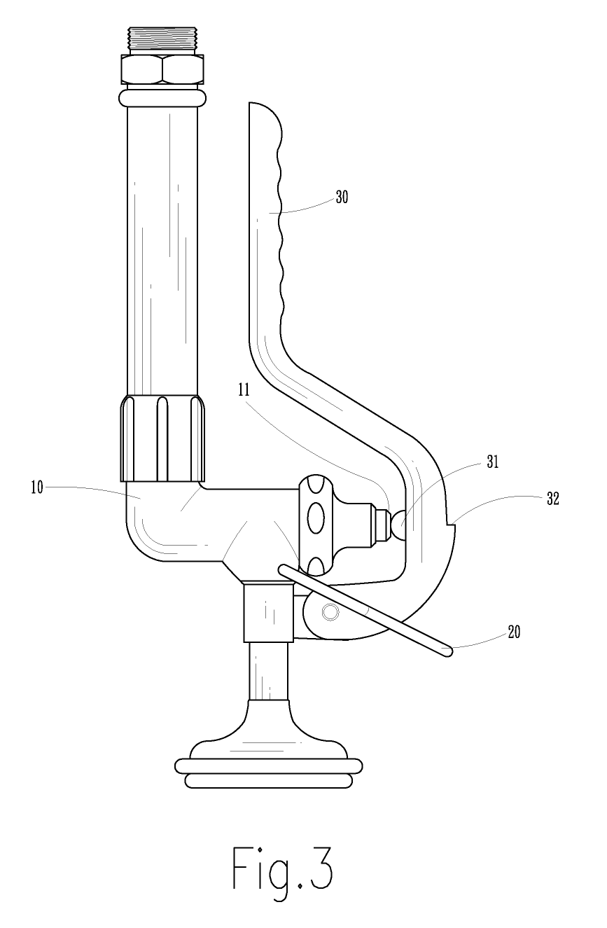

Please refer to FIG. 3, which shows the side view of the sprinkler fixing-switch of the present invention. The sprinkler fixing-switch is connected to control handle 30 of the main body 10 and presses to control the pressure switch 11; in addition, the main body 10 is pivoted with a clicked-in fixing part 20 and the control handle 30 is installed with clicked-in control section 32; through the pressure control of pressure switch 11 by control handle 30 connected to the main body 10, the clicked-in fixing part 20 installed on main body 10 controls the clicked-in control section 32 installed in the control handle 30 so that the control handle 30 presses and controls the pressure switch 11 installed on the main body 10 so as to achieve the effect of ease in control and operation.

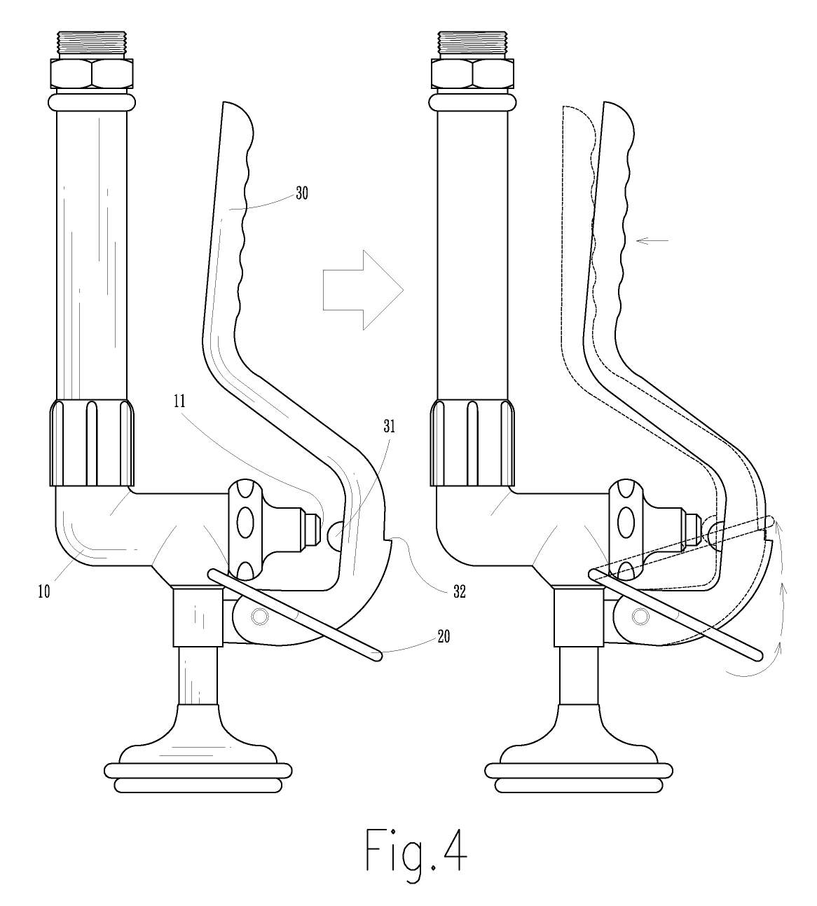

FIG. 4 illustrates the action state of the sprinkler fixing-switch of the present invention, wherein the control handle 30 is restrained through the clicked-in fixing part 20, i.e. pressing control handle 30 so that the protruding point pressing section 31 installed is used to press against the pressure switch 11 installed on the main body 10. When the clicked-in fixing part 20 pivoted in the main body 10 is lifted up, the clicked-in fixing part 20 is clicked into the clicked-in control section 32 installed in the control handle 30 so that the pressure switch 11 installed on the main body 10 presents continuous open state. And to close the pressure switch 11, the clicked-in fixing part 20 escapes from the clicked-in control section 32 installed in the control handle 30, or by pressing against control handle 30 the clicked-in fixing part 20 escapes from the clicked-in control section 32 of the control handle 30 in order to achieve the effect of ease in control and operation.

Below are the advantages of the present invention:

1. Good controllability: Only by lifting the clicked-in control section after pressing the control handle is required to maintain the pressure switch of the main body in the opening state and release the clicked-in fixing part from the clicked-in control section of the control handle and the pressure switch of the main body can be controlled to become fixed closed state, hence its controllability is good.

2. Easy to use: After use it is only required to press the control handle for the clicked-in fixing part to escape from the clicked-in control section of the control handle, hence it is extremely easy to use.

To summarize, the present invention indeed could achieve the various functions and purposes stated above and therefore meets the requirement of patent application, hence the application of patent.

I claim,

1. A sprinkler fixing-switch comprising:
a main body, said main body is installed with a pressure switch;
a clicked-in fixing part, said clicked-in fixing part is connected to main body;
a control handle, said control handle is installed in the main body, and said control handle is clicked together with clicked-in fixing part so that the control handle is pressed against the pressure switch of the main body.

2. The sprinkler fixing-switch as stated in claim 1, wherein the main body is installed with two connecting holes; said connecting hole is installed in the other side of the pressure switch.

3. The sprinkler fixing-switch as stated in claim 1 or 2, wherein the clicked-in fixing part is installed with connecting-end section; said connecting-end section is clicked-in and fixed to the connecting hole of main body such that the clicked-in fixing part is clicked-in and connecting to main body.

4. The sprinkler fixing-switch as stated in claim 1, wherein the control handle is installed with a protruding point control section, said protruding point control section is pressed against the pressure switch of the main body.

5. The sprinkler fixing-switch as stated in claim 1, wherein the control handle is installed with a clicked-in control section; said clicked-in control section is clicked in with the clicked-in fixing part connected to main body, and enabling the control handle to press against the pressure switch of main body.
